(19) United States
(12) Patent Application Publication
(10) Pub. No.: US 2025/0196096 A1
(43) Pub. Date: Jun. 19, 2025

(54) ADSORBENT

(71) Applicant: FUJIFILM Corporation, Tokyo (JP)

(72) Inventor: Koji HIRONAKA, Kanagawa (JP)

(73) Assignee: FUJIFILM Corporation, Tokyo (JP)

(21) Appl. No.: 19/067,971

(22) Filed: Mar. 2, 2025

Related U.S. Application Data
(63) Continuation of application No. PCT/JP2023/035153, filed on Sep. 27, 2023.

(30) Foreign Application Priority Data
Sep. 30, 2022 (JP) 2022-158664

(51) Int. Cl. B01J 20/22

(52) U.S. Cl. CPC B01J 20/226

(57) ABSTRACT

An object of the present invention is to provide an adsorbent which has excellent carbon dioxide adsorptivity and excellent properties.

The adsorbent of the present invention contains a metal-organic framework and an aliphatic amine compound containing at least two nitrogen atoms, in which the metal-organic framework contains a ligand represented by Formula (I) and a metal component selected from the group consisting of a metal cluster and a metal ion.

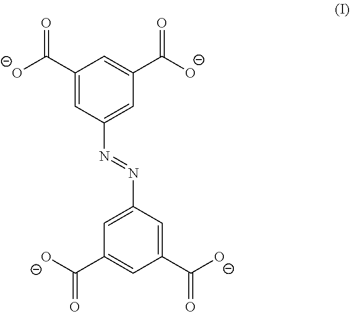 [SMILES: O=C([O-])c1cc(/N=N/c2cc(C(=O)[O-])cc(C(=O)[O-])c2)cc(C(=O)[O-])c1]

### CROSS-REFERENCE TO RELATED APPLICATIONS

This application is a Continuation of PCT International Application No. PCT/JP2023/035153 filed on Sep. 27, 2023, which claims priority under 35 U.S.C. § 119(a) to Japanese Patent Application No. 2022-158664 filed on Sep. 30, 2022. The above applications are hereby expressly incorporated by reference, in their entirety, into the present application.

### BACKGROUND OF THE INVENTION

### 1. Field of the Invention

The present invention relates to an adsorbent.

### 2. Description of the Related Art

Various studies have been conducted about metal-organic frameworks (MOF) in which metal ions or metal clusters and polydentate ligands form a two- to three-dimensional coordination network.

In particular, the above-described metal-organic frameworks has been expected as a material capable of adsorbing a gas (for example, carbon dioxide). For example, JP2021-503366A discloses an adsorbent in which a polyamine such as triamine, tetramine, and pentamine is grafted onto a metal-organic skeleton (metal-organic framework) such as Mg₂(dobpdc) (dobpdc⁴⁻=4,4′-dioxidobiphenyl-3,3′-dicarboxylate) through coordination to a plurality of metal sites, as an adsorbent for CO₂ supplementary use.

### SUMMARY OF THE INVENTION

As a result of studying the adsorbent disclosed in JP2021-503366A, the present inventors have found that the adsorbent has poor properties, which results in poor handleability. That is, it is clarified that there is room for improving the properties of the adsorbent to be easily handled.

Therefore, an object of the present invention is to provide an adsorbent which has excellent carbon dioxide adsorptivity and excellent properties.

As a result of intensive studies to achieve the above-described objects, the present inventors have found that the above-described objects can be achieved by the following configurations, and have completed the present invention.

[1] An adsorbent comprising:
a metal-organic framework; and
an aliphatic amine compound containing at least two nitrogen atoms,
in which the metal-organic framework contains a ligand represented by Formula (I) described later and a metal component selected from the group consisting of a metal cluster and a metal ion.

[2] The adsorbent according to [1],
in which the aliphatic amine compound contains a primary amino group or a secondary amino group.

[3] The adsorbent according to [1] or [2],
in which the aliphatic amine compound is a compound represented by Formula (2) described later.

[4] The adsorbent according to [3],
in which L¹ represents an alkylene group containing —NH—.
[5] The adsorbent according to any one of [1] to [4],
in which the metal cluster and the metal ion include a Fe ion.

According to the present invention, it is possible to provide an adsorbent which has excellent carbon dioxide adsorptivity and excellent properties.

### DESCRIPTION OF THE PREFERRED EMBODIMENTS

Hereinafter, the present invention will be described in detail.

Although configuration requirements to be described below are described based on representative embodiments of the present invention, the present invention is not limited to the embodiments.

In the present specification, a numerical range expressed using “to” means a range that includes the proceeding and succeeding numerical values of “to” as a lower limit value and an upper limit value, respectively.

In addition, regarding numerical ranges that are described stepwise in the present specification, an upper limit value or a lower limit value described in a numerical range may be replaced with an upper limit value or a lower limit value of another stepwise numerical range. In addition, in the range of numerical values described in the present specification, an upper limit value and a lower limit value disclosed in a certain range of numerical values may be replaced with values shown in Examples.

### [Adsorbent]

The adsorbent according to the embodiment of the present invention contains a metal-organic framework and an aliphatic amine compound containing at least two nitrogen atoms (hereinafter, also referred to as “specific aliphatic amine compound”), in which the metal-organic framework contains a ligand represented by Formula (I) described later and a metal component selected from the group consisting of a metal cluster and a metal ion.

In recent years, the present inventors have conducted studies on a combination of a ligand constituting a metal-organic framework and the specific aliphatic amine compound, and have found that an adsorbent having the above-described configuration has excellent carbon dioxide adsorptivity and excellent handleability.

Here, the metal-organic framework is a material formed of a metal component selected from the group consisting of metal clusters and metal ions, and a ligand capable of coordinating with the metal component; and is usually a material in which the metal component as an inorganic matter and the ligand are self-assembled and bound through a coordinate bond. In the adsorbent according to the embodiment of the present invention, it is presumed that the specific aliphatic amine compound is present in a state of being encompassed in voids of the metal-organic framework, and/or the specific aliphatic amine compound encompassed in the voids of the metal-organic framework is adsorbed and present by a chemical bond with the metal-organic framework. The adsorbent according to the embodiment of the present invention can adsorb carbon dioxide by a reaction between the specific aliphatic amine compound contained in the adsorbent and carbon dioxide (carbamic acid is generated by the reaction between the two).

In addition, the properties of excellent handleability are properties in which adhesiveness or stickiness to a container or the like is small and fluidity is excellent. That is, in a case where the adhesiveness or the stickiness is high, the container, filter, or the like is contaminated, load of washing increases, and economic efficiency is deteriorated due to loss of the adsorbent caused by the adhesion. In addition, in a case where the fluidity is low, efficiency of the work of filtering a liquid containing the adsorbent is lowered, which is particularly a hindrance in a case of producing on a large scale.

Hereinafter, the fact that the adsorbent has more excellent carbon dioxide adsorptivity and/or the fact that the adsorbent has more excellent handleability may be referred to as “effect of the present invention is more excellent”.

### [Metal-Organic Framework]

The metal-organic framework contains a metal component selected from the group consisting of a metal cluster and a metal ion, and a ligand represented by Formula (I). In the metal-organic framework, the metal component and the ligand are bonded through a coordinate bond, and nanopores having a regular size and arrangement are formed.

### <Metal Component>

The metal component is selected from the group consisting of a metal cluster and a metal ion.

The metal cluster includes one metal ion or two or more metal ions. In addition, the metal cluster may further include one anion or two or more anions, other than the metal ion.

From the viewpoint that the metal cluster is easily formed, the metal ion is preferably a metal ion selected from the group consisting of Mg²⁺, Ca²⁺, Sr²⁺, Ba²⁺, Ti⁴⁺, Zr⁴⁺, Hf⁴⁺, V⁵⁺, V⁴⁺, V³⁺, V²⁺, Mn²⁺, Re²⁺, Fe³⁺, Fe²⁺, Ru³⁺, Ru²⁺, Os²⁺, Co²⁺, Rh²⁺, Ir²⁺, Ni²⁺, Pd²⁺, Pt²⁺, Cu²⁺, Zn²⁺, Cd²⁺, Hg²⁺, Si²⁺, Ge²⁺, Sn²⁺, and Pb²⁺; more preferably a metal ion selected from the group consisting of Ni²⁺, Mn²⁺, Zn²⁺, Ti⁴⁺, Zr⁴⁺, Co²⁺, Fe³⁺, Fe²⁺, and Cu²⁺; still more preferably a metal ion selected from the group consisting of Co²⁺, Fe³⁺, and Fe²⁺; and particularly preferably a metal ion selected from the group consisting of Fe³⁺ and Fe²⁺. That is, a Fe ion such as Fe³⁺ and Fe²⁺ is particularly preferable.

Examples of the anion constituting the metal cluster include anions consisting of non-metal elements of Groups 14 to 17 of the periodic table (long-period periodic table), and an anion consisting of one or two or more elements of O, N, and S is preferable. The anion is preferably an anion selected from the group consisting of O₂₋, OH⁻, sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, sulfide, hydrogen sulfate, selenide, selenate, hydrogen selenate, telluride, tellurate, hydrogen tellurate, nitride, phosphide, arsenide, arsenate, hydrogen arsenate, dihydrogen arsenate, antimonide, antimonate, hydrogen antimonate, dihydrogen antimonate, fluoride, boride, borate, hydrogen borate, perchlorate, chlorite, hypochlorite, perbromate, bromite, hypobromite, periodate, and hypoiodite; and from the viewpoint that the metal cluster is easily formed, O²⁻, OH⁻, or carbonate is more preferable.

As the metal cluster, a metal cluster represented by Formula (X) is preferable.

MₚY_{q} Formula (X)

M represents a metal ion, and preferred metal ions are as described above. Y represents an anion consisting of non-metal elements of Groups 14 to 17 of the periodic table, and preferred anions are as described above. p represents an integer of 1 to 10. q represents an integer of 1 or more, and preferably an integer of 1 to 10. q is adjusted such that the metal cluster has a predetermined charge.

Examples of the metal cluster include FeO₆, Fe₃O, Zn₄O, AlO₆, Zn₂(CO₂)₄, Cu₂(CO₂)₄, CrO₆, Co₂(CO₂)₄, Zr₆O₄(OH)₄, Fe₂CoO, Ti₈O₈(OH)₄, and Zn₂O₂(CO₂)₂.

The metal ion is not particularly limited, and examples thereof include those exemplified above for the metal ion contained in the metal cluster.

From the viewpoint that the effect of the present invention is more excellent, the metal cluster and the metal ion in the metal component preferably contain a Fe ion, and more preferably contain a metal ion selected from the group consisting of Fe³⁺ and Fe²⁺.

### <Ligand Represented by Formula (I)>

The metal-organic framework contains a ligand represented by Formula (I).

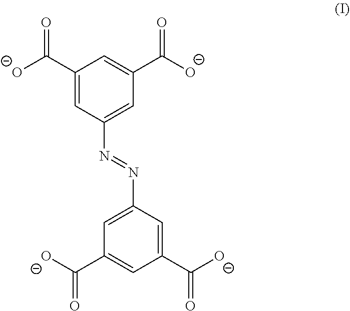 [SMILES: O=C([O-])c1cc(/N=N/c2cc(C(=O)[O-])cc(C(=O)[O-])c2)cc(C(=O)[O-])c1]

In the ligand represented by Formula (I), a moiety represented by a carboxy anion, specified in the formula, may have a delocalized on two oxygens as described below.

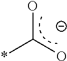 [SMILES: *C(O)O]

The metal-organic framework may contain a ligand other than the ligand represented by Formula (I) described above. Examples of other ligands include 4,4′-ethylenedipyridine, 4,4′-bipyridyl, pyrazine, 1,4-diazabicyclo[2.2.2]octane, terephthalic acid, and 4,4′-biphenyldicarboxylic acid.

### <Method for Producing Metal-Organic Framework>

A method for producing the metal-organic framework includes a step X of mixing a metal salt with a raw material component of various ligands (hereinafter, also referred to as “ligand raw material component”) including the ligand represented by Formula (I) in the presence of a solvent to produce the metal-organic framework (hereinafter, also referred to as “step X”).

Hereinafter, first, various components which can be used for the production will be described.

### (Metal Salt)

The metal salt is a raw material component capable of producing a metal cluster or a metal ion in the solvent.

The metal salt is not particularly limited, and examples thereof include metal nitrates, metal chlorides, metal acetates, metal sulfates, metal hydrogen sulfates, metal bromides, metal carbonates, metal phosphates, and derivatives thereof (for example, monohydrate derivatives and polyhydrate derivatives).

A metal atom contained in the metal salt is preferably a metal atom selected from the group consisting of Fe, Mg, Ca, Sr, Ba, Ti, Zr, Hf, V, Mn, Re, Ru, Os, Co, Rh, Ir, Ni, Pd, Pt, Cu, Zn, Cd, Hg, Si, Ge, Sn, and Pb; more preferably a metal atom selected from the group consisting of Ni, Mn, Fe, Zn, Ti, Zr, Co, and Cu; and still more preferably Fe (iron atom) or Co (cobalt atom).

Examples of the metal salt include zinc nitrate (Zn(NO₃)₂·xH₂O), titanium nitrate (Ti(NO₃)₄·xH₂O), cobalt nitrate (Co(NO₃)₂·xH₂O), iron nitrate (III) (Fe(NO₃)₃·xH₂O), iron nitrate (II) (Fe(NO₃)₂·xH₂O); zinc chloride (ZnCl₂·xH₂O), titanium chloride (TiCl₄·xH₂O), zirconium chloride (ZrCl₄·xH₂O), cobalt chloride (CoCl₂·xH₂O), iron chloride (III) (FeCl₃·xH₂O), iron chloride (II) (FeCl₂·xH₂O); zinc acetate (Zn(CH₃COO)₂·xH₂O), titanium acetate (Ti(CH₃COO)₄·xH₂O), zirconium acetate (Zr(CH₃COO)₄·xH₂O), cobalt acetate (Co(CH₃COO)₂·xH₂O), iron acetate (III) (Fe(CH₃COO)₃·xH₂O), iron acetate (II) (Fe(CH₃COO)₂·xH₂O); zinc sulfate (ZnSO₄·xH₂O), titanium sulfate (Ti(SO₄)₂·xH₂O), zirconium sulfate (Zr(SO₄)₂·xH₂O), cobalt sulfate (CoSO₄·xH₂O), iron sulfate (III) (Fe₂(SO₄)₃·xH₂O), iron sulfate (II) (FeSO₄·xH₂O); zinc hydroxide (Zn(OH)₂·xH₂O), titanium hydroxide (Ti(OH)₄·xH₂O), zirconium hydroxide (Zr(OH)₄·xH₂O), cobalt hydroxide (Co(OH)₂·xH₂O), iron hydroxide (III) (Fe(OH)₃·xH₂O), iron hydroxide (II) (Fe(OH)₂·xH₂O); zinc bromide (ZnBr₂·xH₂O), titanium bromide (TiBr₄·xH₂O), zirconium bromide (ZrBr₄·xH₂O), cobalt bromide (CoBr₂·xH₂O), iron bromide (III) (FeBr₃·xH₂O), iron bromide (II) (FeBr₂·xH₂O); zinc carbonate (ZnCO₃·xH₂O), cobalt carbonate (CoCO₃·xH₂O), and iron carbonate (III) (Fe₂(CO₃)₃·xH₂O). x is a number of 0 to 12.

### (Ligand Raw Material Component)

The ligand raw material component is a raw material component capable of generating the ligand in the metal-organic framework.

Examples of the ligand raw material component include an alkali metal salt of the ligand represented by Formula (I), and a compound in which a carboxy anion moiety in the ligand represented by Formula (I) is COOX (X represents Li, Na, K, or Cs) is preferable.

### (Solvent)

The solvent preferably includes a solvent having a boiling point of 100° C. to 300° C.

The above-described boiling point means a boiling point at 1 atm.

The organic solvent having a boiling point of 100° C. or higher is not particularly limited; and examples thereof include DMF (N,N-dimethylformamide, boiling point: 153° C.), acetic acid (boiling point: 118° C.), DMSO (dimethyl sulfoxide, boiling point: 189° C.), ethylene glycol (boiling point: 197° C.), NMP (N-methylpyrrolidone, boiling point: 202° C.), NEP (N-ethylpyrrolidone, boiling point: 218° C.), DMAc (N,N-dimethylacetamide, boiling point: 165° C.), sulfolane (boiling point: 285° C.), 1,3-dimethyl-2-imidazolidinone (boiling point: 220° C.), propylene glycol (boiling point: 188° C.), 2-pyrrolidone (boiling point: 245° C.), diethylene glycol dimethyl ether (boiling point: 162° C.), diethylene glycol monoethyl ether acetate (boiling point: 218° C.), propylene glycol 1-monomethyl ether 2-acetate (boiling point 146° C.), and propylene glycol 1-monomethyl ether (boiling point: 120° C.).

Among these, it is preferable to use two or more kinds of organic solvents having a boiling point of 100° C. or higher in combination; it is more preferable to use an acetic acid and an organic solvent having a boiling point of 100° C. or higher, other than the acetic acid, in combination; it is still more preferable to use an acetic acid and at least one selected from the group consisting of DMF, DMSO, propylene glycol 1-monomethyl ether, and ethylene glycol in combination; it is particularly preferable to use an acetic acid and at least one selected from the group consisting of DMF, propylene glycol 1-monomethyl ether, and ethylene glycol in combination; and it is most preferable to use an acetic acid and DMF in combination.

A mixing ratio (mass ratio) of an acetic acid to an organic solvent having a boiling point of 100° C. or higher, other than the acetic acid, is preferably 10/90 to 90/10, more preferably 20/80 to 80/20, and still more preferably 30/70 to 70/30.

The solvent may include a solvent other than the above-described organic solvent having a boiling point of 100° C. or higher.

Examples of other solvents include water and an organic solvent having a boiling point of lower than 100° C. Examples of the organic solvent having a boiling point of lower than 100° C. include alcohol and ether.

A content of the organic solvent having a boiling point of 100° C. or higher in the solvent is preferably 20% by mass or more, more preferably 30% by mass or more, still more preferably 50% by mass or more, particularly preferably 70% by mass or more, and most preferably 90% by mass or more with respect to the total mass of the solvent. The upper limit value of the content of the organic solvent having a boiling point of 100° C. or higher is not particularly limited, but is 100% by mass with respect to the total mass of the solvent.

In addition, a content of water in the solvent is 0% to 90% by mass, preferably 0% to 75% by mass, more preferably 0% to 50% by mass, and still more preferably 0% to 10% by mass with respect to the total mass of the solvent.

From the viewpoint of environment and cost, water is preferably used as the solvent, and water and an acetic acid are more preferably used in combination.

A mixing ratio (number of moles of the metal salt/number of moles of the ligand raw material component) of the metal salt to the ligand raw material component can be appropriately selected depending on the type of the metal salt and the ligand raw material component used, and for example, it is preferably 1/1 to 5/1 and more preferably 2/1 to 4/1.

A proportion of the total mass of the metal salt and the ligand raw material component to the content of the solvent (total mass of the metal salt and the ligand raw material component/content of the solvent) is not particularly limited, but is preferably 0.5% by mass or more, more preferably 1% by mass or more, and still more preferably 3% by mass or more. The upper limit value thereof is not particularly limited, but is preferably 30% by mass or less, and more preferably 20% by mass or less.

### (Production Procedure)

A method of mixing the metal salt and the ligand raw material component is not particularly limited, and examples thereof include a method of adding the metal salt and the ligand raw material component to the solvent and stirring the obtained solution.

The step X may be performed under heating conditions, and a heating temperature is not particularly limited, but is preferably 100° C. to 200° C. A heating time is not particularly limited, and from the viewpoint of productivity, it is preferably 1 to 120 hours and more preferably 3 to 48 hours.

Examples of the method of carrying out the heating treatment include a method in which a solution containing the metal salt, the ligand raw material component, and the solvent is put into a pressure-resistant container such as an autoclave, and pressurized at a high temperature, and a method in which the heating treatment is performed in the atmosphere using a heating device provided with a reflux tower.

The step X is preferably performed under an environment of 1 to 3 atm, and more preferably 1 atm (in the atmosphere).

In addition, the method for producing the metal-organic framework may include other steps in addition to the above-described step X.

Examples of the other steps include a purification treatment for removing unreacted substances, and a drying treatment.

Examples of the purification treatment include a washing treatment using a solvent. The washing treatment using a solvent is a method of bringing the solvent into contact with the metal-organic framework, and examples thereof include a method of adding the metal-organic framework to the solvent, and as necessary, subjecting the mixed solution to a heating treatment.

A content of the metal-organic framework in the adsorbent is preferably 20% to 95% by mass, more preferably 30% to 90% by mass, and still more preferably 40% to 85% by mass with respect to the total mass of the adsorbent.

### [Aliphatic Amine Compound]

The adsorbent contains an aliphatic amine compound containing at least two nitrogen atoms (specific aliphatic amine compound).

The number of nitrogen atoms contained in the specific aliphatic amine compound is not particularly limited as long as it is 2 or more. The upper limit value of the number of nitrogen atoms contained in the specific aliphatic amine compound is preferably 5 or less, more preferably 4 or less, and still more preferably 3 or less.

It is preferable that the specific aliphatic amine compound contains a primary amino group (—NH₂) and a secondary amino group (—NHR^{A}).

In —NHR^{A} as the secondary amino group, R^{A} represents a monovalent organic group.

The monovalent organic group represented by R^{A} is not particularly limited, but is preferably, for example, an alkyl group. The number of carbon atoms in the above-described alkyl group is preferably 1 to 10, more preferably 1 to 6, and still more preferably 1 to 3.

Specific examples of the specific aliphatic amine compound include a compound represented by Formula (2).

R¹-L¹-R² Formula (2):

In Formula (2), R¹ and R² each independently represent a primary amino group or a secondary amino group. Examples of the primary amino group or the secondary amino group include the same groups as the primary amino group and the secondary amino group described above.

In Formula (2), L¹ represents an aliphatic hydrocarbon group which may contain a nitrogen atom.

In a case where the aliphatic hydrocarbon group contains a nitrogen atom, the nitrogen atom is typically contained in a form in which a methylene group (—CH₂—) in the aliphatic hydrocarbon group is substituted with >N— or —NR^{B}—. R^{B} represents a hydrogen atom or a monovalent organic group.

The monovalent organic group represented by R^{B} is not particularly limited, but is preferably, for example, an alkyl group. The number of carbon atoms in the above-described alkyl group is preferably 1 to 10, more preferably 1 to 6, and still more preferably 1 to 3.

In addition, in a case where the methylene group (—CH₂—) in the aliphatic hydrocarbon group is substituted with >N— or —NR^{B}—, a bonding position between R¹ and R² in the aliphatic hydrocarbon group is preferably a carbon atom.

Examples of the number of nitrogen atoms in L¹ include 0 to 6, and 0 to 4 is preferable.

Examples of the aliphatic hydrocarbon group include an alkylene group.

The alkylene group may be linear, branched, or cyclic, and is preferably linear or branched and more preferably linear.

The number of carbon atoms in the alkylene group is preferably 1 to 30, more preferably 2 to 18, still more preferably 2 to 12, and particularly preferably 2 to 8.

In addition, in the alkylene group, a methylene group (—CH₂—) in the chain may be substituted with >N— or —NR^{B}—. R^{B} is as described above.

In a case where the methylene group (—CH₂—) in the alkylene group is substituted with >N— or —NR^{B}—, a bonding position between R¹ and R² in the alkylene group is preferably a carbon atom.

From the viewpoint that the effect of the present invention is more excellent, the aliphatic hydrocarbon group which may contain a nitrogen atom, represented by L¹, is preferably an alkylene group in which a methylene group (—CH₂—) in the chain may be substituted with —NH— (that is, an alkylene group which may contain —NH—), and more preferably an alkylene group containing —NH—.

As the specific aliphatic amine compound, a compound represented by Formula (3) is also preferable.

NH₂-(L^{3A}-NH)ₐ-L^{3B}-(NH-L^{3C})_{b}-NH₂ Formula (3):

In Formula (3), L^{3A}, L^{3B}, and L^{3C} each independently represent a linear or branched (preferably linear) alkylene group having 2 to 6 carbon atoms. The number of carbon atoms in the alkylene group is preferably 2 to 4, more preferably 2 or 3, and still more preferably 2.

In Formula (3), a and b each independently represent an integer of 0 to 3. From the viewpoint that the effect of the present invention is more excellent, it is preferable that a and b each independently represent an integer of 0 or 1. From the viewpoint that reusability of the adsorbent (reproducibility of adsorption ability in a case of being repeatedly used) is more excellent, it is also preferable that a and b represent 0.

In addition, in Formula (3), a plurality of L^{3A}'s may be the same or different from each other, and a plurality of L^{3C}'s may be the same or different from each other.

The specific aliphatic amine compound may be a polymer. Examples of the specific aliphatic amine compound as a polymer include polyethyleneimine.

Examples of the specific aliphatic amine compound include ethylenediamine, diethylenetriamine, triethylenetetramine, tetraethylenepentamine, trisaminoethylamine, 1,4-butanediamine, hexamethylenediamine, N-(2-aminoethyl)-1,3-propanediamine, bis(3-aminopropyl)amine, N-(3-aminopropyl)-1,4-diaminobutane, N,N′-bis(2-aminoethyl)-1,3-propanediamine, 1,2-bis(3-aminopropylamino)ethane, N,N′-bis(3-aminopropyl)-1,3-propanediamine, N,N′-bis(3-aminopropyl)-1,4-diaminobutane, N,N′-dimethylethylenediamine, 2,2-dimethyl-1,3-propanediamine, and polyethyleneimine.

A content of the specific aliphatic amine compound in the adsorbent is preferably 5% to 80% by mass, more preferably 10% to 70% by mass, and still more preferably 15% to 60% by mass with respect to the total mass of the adsorbent.

### [Method for Producing Adsorbent]

A method for producing the adsorbent is not particularly limited, and it is preferable that the method includes the following step Y and the following step Z.

Step Y: step of mixing and stirring the specific aliphatic amine compound and the metal-organic framework in the presence of a solvent

Step Z: step of separating the adsorbent from the reaction solution obtained in the step Y

Hereinafter, the step Y and the step Z will be described.

### <Step Y>

In the step Y, the specific aliphatic amine compound and the metal-organic framework are as described above.

Examples of the solvent used in the step Y include methanol, ethanol, and isopropyl alcohol; and from the viewpoint that the effect of the present invention is more excellent, methanol is preferable.

A stirring time in the step Y is, for example, preferably 5 minutes to 12 hours and more preferably 10 minutes to 6 hours.

A temperature during the stirring in the step Y is, for example, preferably 5° C. to 50° C. and more preferably 10° C. to 40° C.

The step Y is preferably a step of mixing a mixed solution (slurry) containing the metal-organic framework and the solvent with the specific aliphatic amine compound, and stirring the mixture (hereinafter, also referred to as “step Y1”).

In the mixed solution containing the metal-organic framework and the solvent in the step Y1, a content of the metal-organic framework is preferably 5% to 99.9% by mass, more preferably 5% to 90% by mass, still more preferably 10% to 70% by mass, and particularly preferably 10% to 50% by mass with respect to the total mass of the mixed solution.

In the reaction solution obtained by mixing the mixed solution (slurry) containing the metal-organic framework and the solvent with the specific aliphatic amine compound in the step Y, a blending amount ratio (specific aliphatic amine compound/metal-organic framework (mass ratio)) of the metal-organic framework and the specific aliphatic amine compound is preferably 10/90 to 90/10, more preferably 20/80 to 80/20, and still more preferably 30/70 to 70/30.

In the method for producing the adsorbent, the metal-organic framework used in the step Y may be washed (co-washed) with the solvent (for example, methanol) used in the step Y, before the step Y.

In addition, in the method for producing the adsorbent, a step of removing adsorbed water, coordinated water, and other coordinated solvents, which can be contained in the metal-organic framework, by performing a heating treatment (for example, a heating treatment under vacuum conditions or in a stream of nitrogen gas or argon gas) or a centrifugation treatment on the metal-organic framework used in the step Y may be performed before the step Y.

### <Step Z>

After the step Y is performed, a step (step Z) of separating the adsorbent from the reaction solution obtained in the step Y is performed.

A method of separating the adsorbent from the reaction solution obtained in the step Y is not particularly limited, and suction filtration, centrifugation, or the like can be applied.

It is preferable to perform a step of drying the obtained adsorbent after separating the adsorbent from the reaction solution. Examples of the drying method include vacuum drying, blast drying, and heat drying.

A heating temperature is, for example, preferably 20° C. to 150° C. and more preferably 30° C. to 130° C.

A drying time is, for example, preferably 10 minutes to 12 hours and more preferably 30 minutes to 6 hours.

Since the adsorbent according to the embodiment of the present invention can selectively adsorb carbon dioxide, the adsorbent can be applied to a carbon dioxide separation device, a sensor, and the like. For example, in a case of a carbon dioxide separation device, the adsorbent according to the embodiment of the present invention can be applied as a material for a carbon dioxide separation membrane. In addition, in a case of a sensor, examples thereof include an aspect in which the adsorbent according to the embodiment of the present invention is disposed on a cantilever type oscillator.

In addition, in the adsorbent according to the embodiment of the present invention, adsorption-desorption of the carbon dioxide is reversible. Most of the carbon dioxide can also be removed from the adsorbent according to the embodiment of the present invention, which has adsorbed the carbon dioxide, by a temperature swing adsorption method, a vacuum swing adsorption method, a pressure swing adsorption method, or the like.

### EXAMPLES

Hereinafter, the present invention will be described in more detail with reference to Examples. The materials, the amounts of materials used, the proportions, the treatment details, the treatment procedure, and the like shown in Examples below may be appropriately modified as long as the modifications do not depart from the spirit of the present invention. Therefore, the scope of the present invention should not be construed as being limited to Examples.

### [Production of Adsorbent]

### Example 1

<Formulation A>

| | |
|---|---|
| TazbNa₄ | 93 g |
| Fe(NO₃)₃•9H₂O | 180 g |
| DMF | 1888 g |
| Acetic acid | 1050 g |

Raw materials were put into a three-necked flask according to the above-described formulation A, and the obtained mixture was stirred at 145° C. for 6 hours in an open atmosphere to synthesize a metal-organic framework PCN-250. The PCN-250 was filtered with a centrifuge, washed with methanol, and filtered again with a centrifuge. 90 g of the obtained PCN-250 was immersed in 500 g of methanol, and 140 g of diethylenetriamine was further added to the obtained slurry. The obtained reaction solution was stirred at 20° C. for 6 hours, subjected to suction filtration, and vacuum-dried to obtain 80 g of a composite (adsorbent 1) of PCN-250 and diethylenetriamine. The PCN-250 is a metal-organic framework represented by [Fe₃(μ₃—O)(H₂O)₂(OH)(Tazb)_{3/2}], and Tazb has the following structure.

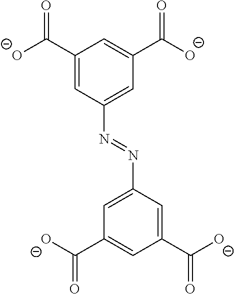 [SMILES: O=C([O-])c1cc(/N=N/c2cc(C(=O)[O-])cc(C(=O)[O-])c2)cc(C(=O)[O-])c1]

### Example 2

A composite (adsorbent 2) of PCN-250 and triethylenetetramine was produced by the same method as in Example 1, except that diethylenetriamine was replaced with triethylenetetramine.

### Comparative Example 1

According to the description in JP2021-503366A, support of diethylenetriamine in toluene was attempted for Mg₂(dobpdc). As a result, it was determined that handleability was poor due to adhesion to the container or solidification of the adsorbent, and the adsorbent was not suitable for practical use.

### [Evaluation]

The following evaluations were carried out for each adsorbent of Examples and Comparative Example.

### [Evaluation of Properties]

In a case where the adsorbent was attached to a container or a filter used for synthesizing the adsorbent in the production of the adsorbent containing the metal-organic framework and the amine compound, the adsorbent could not be easily washed off by washing with methanol, and/or in a case where 10% or more of the adsorbent was solidified to cause loss, it was determined that properties were poor. CO₂ adsorption ability was not evaluated for a sample determined to have poor properties.

In Table 1, a case where it was determined that the properties were good is indicated as “A”, and a case where it was determined that the properties were poor is indicated as “B”.

### [CO₂ Adsorption Ability]

15 g of the adsorbent was spread in a petri dish and placed in a polybucket having an internal volume of 5 L. In addition, after putting a CO₂ monitor (CO₂-M1 manufactured by CUSTOM) in the polybucket, the upper part of the polybucket was covered with a Saran Wrap (registered trademark). A polytube having an inner diameter of 5 mm was inserted into a gap between the polybucket and the Saran Wrap (registered trademark), and air was blown into the polybucket through the polytube. A blowing amount at which the CO₂ concentration in the CO₂ monitor after 3 minutes of blowing air was set to 5,000 to 6,000 ppm.

In a case where the CO₂ concentration after 60 minutes from the blowing was less than 2,000 ppm, it was determined that the CO₂ adsorption ability was good.

In Table 1, a case where the CO₂ adsorption ability was determined to be good is indicated as “A”.

Table 1 is shown below.

TABLE 1

| | Adsorbent | | Evaluation | |
|---|---|---|---|---|
| | Metal- | Aliphatic | | CO₂ |
| | organic | amine | | adsorption |
| | framework | compound | Properties | ability |
| Example 1 | PCN-250 | Diethylenetriamine | A | A |
| Example 2 | PCN-250 | Triethylenetetramine | A | A |
| Compar- | Mg₂(dobpdc) | Diethylenetriamine | B | Not |
| ative | | | | evaluated |
| Example 1 | | | | due to poor |
| | | | | properties |

From the results in Table 1, it is clear that the adsorbents of Examples had excellent carbon dioxide adsorptivity and excellent properties.

On the other hand, in the adsorbents of Comparative Example, adhesion to the container and solidification of the adsorbent occurred, and thus the handleability was poor.

### Example 3

<Formulation A>

| | |
|---|---|
| TazbNa₄ | 93 g |
| Fe(NO₃)₃•9H₂O | 180 g |
| DMF | 1888 g |
| Acetic acid | 1050 g |

Raw materials were put into a three-necked flask according to the above-described formulation A, and the obtained mixture was stirred at 145° C. for 6 hours in an open atmosphere to synthesize a metal-organic framework PCN-250. The PCN-250 was filtered with a centrifuge, washed with methanol, filtered again with a centrifuge, and vacuum-dried at 80° C. for 3 hours.

100 mL of methanol and 30 g of N,N′-dimethylethylenediamine (manufactured by Tokyo Chemical Industry Co., Ltd.) were placed in another three-neck flask, 18 g of the PCN-250 subjected to the above-described vacuum drying treatment was added thereto under stirring at 100 rpm, and the mixture was further stirred at room temperature for 3 hours. The mixture was subjected to suction filtration and dried with a rotary evaporator at 20 mmHg and 40° C. for 1 hour to obtain 17 g of a complex (adsorbent 3) of PCN-250 and N,N′-dimethylethylenediamine.

### Example 4

A composite (adsorbent 4) of PCN-250 and 2,2-dimethyl-1,3-propanediamine was produced by the same method as in Example 3, except that N,N′-dimethylethylenediamine was replaced with 2,2-dimethyl-1,3-propanediamine (manufactured by Tokyo Chemical Industry Co., Ltd.).

### Example 5

A composite (adsorbent 5) of PCN-250 and bis(3-aminopropyl)amine was produced by the same method as in Example 3, except that N,N′-dimethylethylenediamine was replaced with bis(3-aminopropyl)amine (manufactured by FUJIFILM Wako Pure Chemical Corporation).

### Example 6

A composite (adsorbent 6) of PCN-250 and tris(2-aminoethyl)amine was produced by the same method as in Example 3, except that N,N′-dimethylethylenediamine was replaced with tris(2-aminoethyl)amine (manufactured by Tokyo Chemical Industry Co., Ltd.).

### Example 7

A composite (adsorbent 7) of PCN-250 and tetraethylenepentamine was produced by the same method as in Example 3, except that N,N′-dimethylethylenediamine was replaced with tetraethylenepentamine (manufactured by FUJIFILM Wako Pure Chemical Corporation).

### Example 8

A composite (adsorbent 8) of PCN-250 and triethylenetetramine was produced by the same method as in Example 3, except that N,N′-dimethylethylenediamine was replaced with triethylenetetramine (manufactured by Tokyo Chemical Industry Co., Ltd.).

### Example 9

A composite (adsorbent 9) of PCN-250 and diethylenetriamine was produced by the same method as in Example 3, except that N,N′-dimethylethylenediamine was replaced with diethylenetriamine (manufactured by Tokyo Chemical Industry Co., Ltd.).

### Example 10

A composite (adsorbent 10) of PCN-250 and polyethyleneimine was produced by the same method as in Example 3, except that N,N′-dimethylethylenediamine was replaced with polyethyleneimine (manufactured by Sigma-Aldrich Co., LLC).

### [Evaluation]

The following evaluations were carried out for each adsorbent of Examples and Comparative Example.

### [Evaluation of Properties]

In a case where the adsorbent was attached to a container or a filter used for synthesizing the adsorbent in the production of the adsorbent containing the metal-organic framework and the amine compound, the adsorbent could not be easily washed off by washing with methanol, and/or in a case where 10% or more of the adsorbent was solidified to cause loss, it was determined that properties were poor. CO₂ adsorption ability was not evaluated for a sample determined to have poor properties.

In Table 1, a case where it was determined that the properties were good is indicated as “A”, and a case where it was determined that the properties were poor is indicated as “B”.

### [CO₂ Adsorption Ability 1]

16 g of the adsorbent was spread in a petri dish and placed in a polybucket having an internal volume of 5 L. In addition, after putting a CO₂ monitor (CO₂-M1 manufactured by CUSTOM) in the polybucket, the upper part of the polybucket was covered with a Saran Wrap (registered trademark). A polytube having an inner diameter of 5 mm was inserted into a gap between the polybucket and the Saran Wrap (registered trademark), and air was blown into the polybucket through the polytube. A blowing amount at which the CO₂ concentration in the CO₂ monitor after 3 minutes of blowing air was set to 5,000 to 6,000 ppm.

After blowing air, CO₂ adsorption ability was determined as follows according to the CO₂ concentration after 60 minutes.
“A”: less than 1,000 ppm
“B”: 1,000 ppm or more and less than 2,000 ppm
“C”: 2,000 ppm or more

### [CO₂ Adsorption Ability 2] (Evaluation for Repeated Use)

In [CO₂ adsorption ability 1] described above, the CO₂ adsorption ability was determined as follows according to a concentration after repeating blowing air and then allowing to stand for 60 minutes 5 times.
“A”: less than 1,000 ppm
“B”: 1,000 ppm or more and less than 2,000 ppm
“C”: 2,000 ppm or more
   [CO₂ Adsorption Ability 3] (Regeneration Test 1 for CO₂ Adsorption Ability)

In [CO₂ adsorption ability 1] described above, the “blowing air and then allowing to stand for 60 minutes” was repeated 5 times or more, and a CO₂ concentration after 60 minutes was set to be 2,000 ppm or more. After vacuum-drying the adsorbent at 140° C. for 1 hour, the same test as [CO₂ adsorption ability 1] was carried out again, and CO₂ adsorption ability was determined as follows.
“A”: less than 1,000 ppm
“B”: 1,000 ppm or more and less than 2,000 ppm
“C”: 2,000 ppm or more
   [CO₂ Adsorption Ability 4] (Regeneration Test 2 for CO₂ Adsorption Ability)

In [CO₂ adsorption ability 1] described above, the “blowing air and then allowing to stand for 60 minutes” was repeated 5 times or more, and a CO₂ concentration after 60 minutes was set to be 2,000 ppm or more. After vacuum-drying the adsorbent at 100° C. for 1 hour, the same test as [CO₂ adsorption ability 1] was carried out again, and CO₂ adsorption ability was determined as follows.
“A”: less than 1,000 ppm
“B”: 1,000 ppm or more and less than 2,000 ppm
“C”: 2,000 ppm or more
   [CO₂ Adsorption Ability 5] (Regeneration Test 3 for CO₂ Adsorption Ability)

In [CO₂ adsorption ability 1], the “blowing air and then allowing to stand for 60 minutes” was repeated 5 times or more, and a CO₂ concentration after 60 minutes was set to be 2,000 ppm or more. After vacuum-drying the adsorbent at 80° C. for 1 hour, the same test as [CO₂ adsorption ability 1] was carried out again, and CO₂ adsorption ability was determined as follows.

The present test was carried out only on the adsorbent 4.
“A”: less than 1,000 ppm
“B”: 1,000 ppm or more and less than 2,000 ppm
“C”: 2,000 ppm or more

TABLE 2

| | Adsorbent | | | Evaluation | | | | | |
|---|---|---|---|---|---|---|---|---|---|
| | | Metal- | | | CO₂ | CO₂ | CO₂ | CO₂ | CO₂ |
| | | organic | | | adsorption | adsorption | adsorption | adsorption | adsorption |
| | Type | framework | Aliphatic amine compound | Properties | ability 1 | ability 2 | ability 3 | ability 4 | ability 5 |
| Example 3 | Adsorbent 3 | PCN-250 | N,N′-Dimethylethylenediamine | A | A | A | A | A | — |
| Example 4 | Adsorbent 4 | PCN-250 | 2,2-Dimethyl-1,3-propanediamine | A | A | A | A | A | A |
| Example 5 | Adsorbent 5 | PCN-250 | Bis(3-aminopropyl)amine | A | A | A | A | B | — |
| Example 6 | Adsorbent 6 | PCN-250 | Tris(2-aminoethyl)amine | A | A | A | C | C | — |
| Example 7 | Adsorbent 7 | PCN-250 | Tetraethylenepentamine | A | A | C | B | C | — |
| Example 8 | Adsorbent 8 | PCN-250 | Triethylenetetramine | A | A | B | A | C | — |
| Example 9 | Adsorbent 9 | PCN-250 | Diethylenetriamine | A | A | C | C | C | — |
| Example 10 | Adsorbent 10 | PCN-250 | Polyethyleneimine | A | B | C | C | C | — |

From the results in Table 2, it was found that, in a case where the adsorbent was the aliphatic amine compound represented by Formula (3) described above and a and b represented 0, the reusability of the adsorbent (reproducibility of adsorption ability in a case of being repeatedly used) was more excellent.

What is claimed is:

1. An adsorbent comprising:
a metal-organic framework; and
an aliphatic amine compound containing at least two nitrogen atoms,
wherein the metal-organic framework contains a ligand represented by Formula (I) and a metal component selected from the group consisting of a metal cluster and a metal ion,

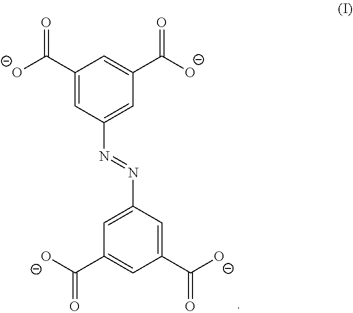 [SMILES: O=C([O-])c1cc(/N=N/c2cc(C(=O)[O-])cc(C(=O)[O-])c2)cc(C(=O)[O-])c1]

2. The adsorbent according to claim 1,
wherein the aliphatic amine compound contains a primary amino group or a secondary amino group.

3. The adsorbent according to claim 1,
wherein the aliphatic amine compound is a compound represented by Formula (2),
R¹-L¹-R² Formula (2):
in Formula (2), R¹ and R² each independently represent a primary amino group or a secondary amino group, and L¹ represents an aliphatic hydrocarbon group which may contain a nitrogen atom.

4. The adsorbent according to claim 3,
wherein L¹ represents an alkylene group containing —NH—.

5. The adsorbent according to claim 1,
wherein the metal cluster and the metal ion include a Fe ion.

6. The adsorbent according to claim 2,
wherein the aliphatic amine compound is a compound represented by Formula (2),
R¹-L¹-R² Formula (2):
in Formula (2), R¹ and R² each independently represent a primary amino group or a secondary amino group, and L¹ represents an aliphatic hydrocarbon group which may contain a nitrogen atom.

7. The adsorbent according to claim 6,
wherein L¹ represents an alkylene group containing —NH—.

8. The adsorbent according to claim 2,
wherein the metal cluster and the metal ion include a Fe ion.

9. The adsorbent according to claim 3,
wherein the metal cluster and the metal ion include a Fe ion.

10. The adsorbent according to claim 4,
wherein the metal cluster and the metal ion include a Fe ion.
